(19) United States
(12) Patent Application Publication
(10) Pub. No.: US 2023/0421510 A1
(43) Pub. Date: Dec. 28, 2023

(54) NETWORK CARD AND BUFFER CONTROL METHOD

(71) Applicant: Nippon Telegraph and Telephone Corporation, Tokyo (JP)

(72) Inventors: Yuki Arikawa, Tokyo (JP); Kenji Tanaka, Tokyo (JP); Tsuyoshi Ito, Tokyo (JP); Tsutomu Takeya, Tokyo (JP); Takeshi Sakamoto, Tokyo (JP)

(21) Appl. No.: 18/251,325

(22) PCT Filed: Nov. 13, 2020
(86) PCT No.: PCT/JP2020/042457

§ 371 Date: May 1, 2023

(51) Int. Cl. H04L 49/20; H04L 49/253; H04L 43/062; H04L 43/0882

(52) U.S. Cl. CPC H04L 49/205; H04L 49/254; H04L 43/062; H04L 43/0882

(57) ABSTRACT

A network card has a plurality of buffers each having different physical performances including a memory access speed or a storage capacity, and a buffer control circuit selects one buffer to be a packet storage destination from among the plurality of buffers on the basis of a priority or a service quality of a packet specified from header information of the packet received by a physical port and the physical performances of the plurality of buffers.

### CROSS-REFERENCE TO RELATED APPLICATIONS

This patent application is a national phase filing under section 371 of PCT application no. PCT/JP2020/042457, filed on Nov. 13, 2020, which application is incorporated herein by reference in its entirety.

### TECHNICAL FIELD

Embodiments of the present invention relate to a buffer control technique for executing arithmetic processing on a packet when controlling transfer of the packet on the basis of priority control of a communication network.

### BACKGROUND

Technological innovation has progressed in many fields such as in machine learning, artificial intelligence (AI), and the Internet of Things (IoT), and the enhancement of services and the provision of added values are being actively performed by utilizing various types of information and data. In such processing, it is necessary to perform a large amount of calculation, and an information processing infrastructure therefor is essential.

For example, Non Patent Literature 1 points out that although attempts to update an existing information processing infrastructure have been developed, it is also a fact that modern computers have not been able to cope with rapidly increasing data, and in order to achieve further evolution in the future, a “post-Moore technique” transcending Moore's Law needs to be established.

As the post-Moore technique, for example, Non Patent Literature 2 discloses a technique called flow-centric computing. In flow-centric computing, a new concept of moving data to a place where a calculation function exists and performing processing has been introduced, in place of the conventional idea of computing in which processing is performed at a place where data exists.

In order to realize flow-centric computing as described above, not only is a broadband communication network necessary for data movement required, but also data movement may not be able to be efficiently performed unless the communication network is efficiently controlled at the same time.

### CITATION LIST

### Patent Literature

Patent Literature 1: JP 2012-44511 A

### Non Patent Literature

Non Patent Literature 1: “NTT Technology Report for Smart World 2020”, Nippon Telegraph and Telephone Corporation, 28 May 2020, [Retrieved on Oct. 19, 2020], Internet <https://www.rd.ntt/_assets/pdf/techreport/NTI_TRFSW_2020_EN_W.pdf>
Non Patent Literature 2: R. Takano and T. Kudoh, “Flow-centric computing leveraged by photonic circuit switching for the post-moore era”, Tenth IEEE/ACM International Symposium on Networks-on-Chip (NOCS), Nara, 2016, pp. 1-3, [Retrieved on Oct. 19, 2020], Internet <https://ieeexplore.ieee.org/abstract/document/7579339>

### SUMMARY

### Technical Problem

In general, for the purpose of efficiently moving data, the way a buffer or a memory that temporarily stores data is configured affects the processing performance of the entire system. There is a technique in which, in a case where there are buffers having different memory access speeds or different power consumption, the buffers are switched by looking at an internal state of the buffers (for example, Patent Literature 1). According to such techniques of the related art, it is possible to preferentially use a buffer having a high memory access speed and low power consumption.

On the other hand, in flow-centric computing via a communication network, processing content or priority is different for each piece of data. Thus, in addition to the priority control of the communication network, it is necessary to allocate the arithmetic processing on the data in consideration of the processing content or the priority for each piece of data. Therefore, in the related art, a buffer control technique for fusing priority control of a communication network and allocation control of arithmetic processing on a packet is not disclosed.

Embodiments of the present invention are intended to solve such a problem, and an embodiment of the present invention provides a buffer control technique capable of fusing priority control of a communication network and allocation control of arithmetic processing on a packet.

### Solution to Problem

According to embodiments of the present invention, there is provided a network card including a plurality of physical ports configured to receive and transmit packets via a transmission line; a plurality of buffers configured to temporarily store a first packet received by the plurality of physical ports; a plurality of arithmetic processing circuits configured to perform predetermined arithmetic processing on a second packet read from the plurality of buffers; and a buffer control circuit configured to store the first packet in any of the plurality of buffers and to control allocation of the second packet to the arithmetic processing circuit and reading from the buffers, in which the plurality of buffers includes buffers having different physical performances including a memory access speed or a storage capacity, and the buffer control circuit specifies a priority or a service quality of the first packet on the basis of header information of the first packet, and selects a buffer to be a storage destination of the first packet from among the plurality of buffers on the basis of the obtained priority or service quality and physical performances of the plurality of buffers.

According to embodiments of the present invention, there is provided a buffer control method used in a network card including a plurality of physical ports configured to receive and transmit packets via a transmission line, a plurality of buffers configured to temporarily store a first packet received by the plurality of physical ports, a plurality of arithmetic processing circuits, of which physical performances including a memory access speed or a storage capacity are different, configured to perform predetermined arithmetic processing on a second packet read from the plurality of buffers, and a buffer control circuit configured to store the first packet in any of the plurality of buffers and to control allocation of the second packet to the arithmetic processing circuit and reading from the buffers, the buffer control method including a first step of causing the buffer control circuit to specify a priority or a service quality of the first packet on the basis of header information of the first packet; and a second step of causing the buffer control circuit to select a buffer to be a storage destination of the first packet from among the plurality of buffers on the basis of the obtained priority or service quality and the physical performances of the plurality of buffers.

### Advantageous Effects of Embodiments of the Invention

According to embodiments of the present invention, it is possible to fuse priority control of a communication network and allocation control of arithmetic processing on a packet, and as a result, the arithmetic processing can be efficiently executed on the packet.

### BRIEF DESCRIPTION OF THE DRAWINGS

FIG. 1 is a block diagram illustrating a configuration of a network card according to a first embodiment.

FIG. 2 is a block diagram illustrating a configuration of a buffer control circuit according to the first embodiment.

FIG. 3 is a flowchart illustrating an operation in a buffer control method for the network card according to the first embodiment.

FIG. 4 is a block diagram illustrating a configuration of a buffer control circuit according to a second embodiment.

FIG. 5 is a flowchart illustrating an operation in a buffer control method for a network card according to the second embodiment.

FIG. 6 is a block diagram illustrating a configuration of a buffer control circuit according to a third embodiment.

FIG. 7 is an explanatory diagram illustrating a buffer selection criterion example.

FIG. 8 is a graph illustrating a buffer selection operation example.

FIG. 9 is a flowchart illustrating an operation in a buffer control method for a network card according to the third embodiment.

FIG. 10 is a block diagram illustrating a configuration of a network card of the related art.

### DETAILED DESCRIPTION OF ILLUSTRATIVE EMBODIMENTS

Next, embodiments of the present invention will be described with reference to the drawings.

### First Embodiment

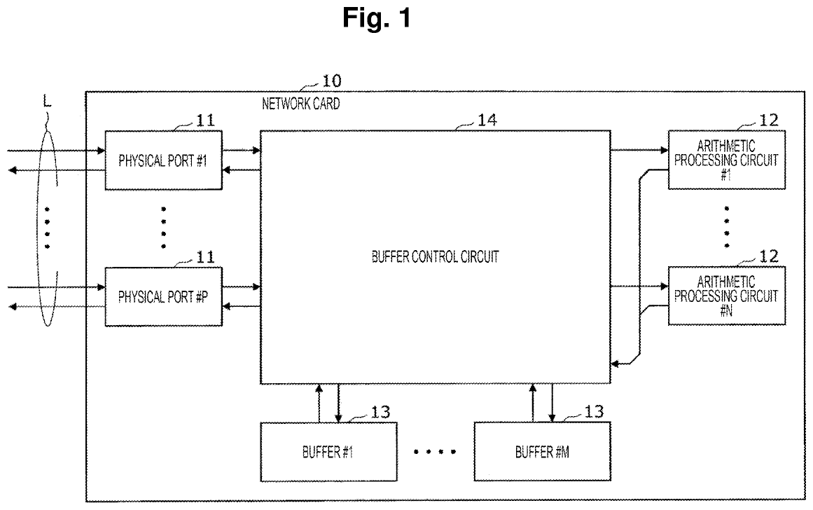

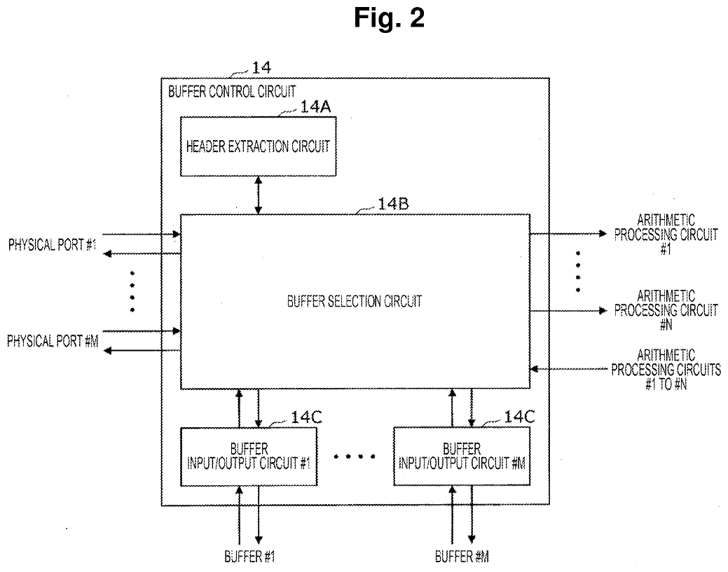

First, a configuration of a network card 10 according to a first embodiment of the present invention will be described with reference to FIGS. 1 and 2. FIG. 1 is a block diagram illustrating a configuration of a network card according to a first embodiment. FIG. 2 is a block diagram illustrating a configuration of a buffer control circuit according to the first embodiment.

### Network Card

A network card (network interface card (NIC)) is also called a network adapter and is an extension device for connecting a device such as a computer to a transmission line. There is a card type network card 10 used in a form of being inserted into an extension slot prepared in a rear surface or a side surface of a casing of a device, and further in the housing, but a network card is not limited thereto. For example, there are a form of being mounted as a circuit in a casing of a device, for example, on a board on which a control circuit 15 such as a CPU is mounted, and a form of being connected to an interface for a peripheral device such as a Universal Serial Bus (USB) port.

As illustrated in FIG. 1, the network card 10 according to the present embodiment includes, as main circuit units, P (where P is an integer of 1 or more) physical ports (#1 to #P) 11, N (where N is an integer of 2 or more) arithmetic processing circuits 12 (#1 to #N), a buffer control circuit 14, M (where M is an integer of 2 or more) buffers 13, and a control circuit 15.

As a whole, the network card 10 is configured such that the buffer control circuit temporarily stores a packet (first packet) such as a data packet received by the physical port 11 via a transmission line L in the buffer 13, and the arithmetic processing circuit 12 executes predetermined arithmetic processing on a packet (second packet) sequentially read from the buffer 13, stores an obtained arithmetic processing result in the packet, and transmits the packet from the physical port 11.

In this case, the buffer control circuit is configured to extract header information of each packet and select any one or a plurality of buffers from among the buffers 13 having different physical performances as a packet storage destination on the basis of the header information.

### Physical Port

The physical port 11 (#1 to #P) is an input/output interface with an external device, an external network, and an external connection device (not illustrated), and has a function of receiving a packet by using an optical or electrical signal input from the outside via the transmission line L and a function of outputting a packet for transmitting an arithmetic processing result obtained by the network card 10 to the outside via the transmission line L by using an optical or electrical signal. Specifically, the physical port 11 includes any input/output interface such as an Ethernet (registered trademark) port, an InfiniBand port, or an I/O serial interface such as PCI Express. However, the physical port may include not only an input/output interface available in general commercial technologies but also a uniquely defined interface.

### Arithmetic Processing Circuit

The arithmetic processing circuit 12 (#1 to #N) has a function of performing predetermined arithmetic processing (arithmetic operation or processing) on data included in a packet read from the buffer 13 and a function of outputting an obtained arithmetic processing result (arithmetic result or processing result). The output from the arithmetic processing circuit 12 is stored in a packet by the buffer control circuit 14 and then output from the physical port 11 to the above external device, external network, and external connection device via the transmission line L.

The arithmetic processing circuit 12 may be realized by software operating on a central processing unit (CPU) or a graphics processing unit (GPU) or may be realized by hardware such as a large scale integration (LSI) circuit formed in a field programmable gate array (FPGA) or an application specific integrated circuit (ASIC). The arithmetic processing circuit 12 may be implemented on the same physical device as any or all of the physical port 11, the buffer 13, the buffer control circuit 14, and the control circuit 15. Each of the arithmetic processing circuits 12 may be configured by a device of a different type or a dedicated circuit that provides a function of a different type or may be configured by the same processor to be able to be used for general purposes such as a general-purpose processor.

### Buffer

The buffer 13 is configured to temporarily store a packet input from the arithmetic processing circuit 12. These buffers 13 include buffers having different physical performances such as a writing/reading speed and a storage capacity of data.

For example, in the network card 10, a device that performs communication protocol processing, for example, a buffer (hereinafter, also referred to as an on-chip buffer) including an on-chip memory provided inside a field programmable gate array (FPGA) or an application specific integrated circuit (ASIC) has a feature that a memory access speed, that is, a speed of reading and writing data is relatively high although a storage capacity is relatively small. Such an on-chip memory is suitable for storing data of a service that requires low-delay processing, data with high priority, and data of a service with a small storage capacity.

On the other hand, a buffer (hereinafter, also referred to as an on-board buffer) provided outside a device that performs communication protocol processing and including an on-board memory provided on the same printed circuit board as the device has a feature that a memory access speed, that is, a data reading/writing speed is relatively low. It is known that the on-board memory has relatively large power consumption associated with memory access. However, the on-board memory has a large storage capacity and is suitable for storing data in a case where data for which a processing delay is allowed or a service for which there is a greater need to secure a storage capacity, for example, a high-definition moving image is analyzed by using a large-scale neural network, the time required for subsequent arithmetic operations is longer than the memory access speed, and a processing delay associated with memory access can be ignored.

### Buffer Control Circuit

As a whole, the buffer control circuit 14 is configured to extract header information from a packet header of a packet input from the physical port 11, select the buffer 13 for storing the packet on the basis of the extracted header information, and store the packet in the selected buffer 13.

As illustrated in FIG. 2, a header extraction circuit 14A, a buffer selection circuit 14B, and M buffer input/output circuits 14C are provided.

### Header Extraction Circuit

The header extraction circuit 14A is configured to analyze and extract header information stored in a packet header of a packet input from the physical port 11. Specifically, information for specifying a priority or a user ID of the packet and details of arithmetic operation to be performed on the packet is extracted as header information from a predetermined field of the packet.

### Buffer Input/Output Circuit

The buffer input/output circuit 14C is configured to output a packet input from the physical port 11 to one or a plurality of buffers 13 selected by the buffer selection circuit 14B and to read a stored packet from the one or plurality of buffers 13 selected by the buffer selection circuit 14B.

### Buffer Selection Circuit

The buffer selection circuit 14B is configured to select one or a plurality of buffers 13 for storing a packet input from the physical port 11 on the basis of header information extracted by the header extraction circuit 14A, to store the packet in the selected buffer 13 via the buffer input/output circuit 14C, to select the buffer 13 in descending order of priority, to read the packet from the selected buffer 13 via the buffer input/output circuit 14C, and to output the packet to the arithmetic processing circuit 12 corresponding to the packet.

The buffer control circuit 14 (buffer selection circuit 14B) selects the buffer 13 for storing the packet according to the priority of the packet input from the physical port 11. For example, as the priority of the packet becomes higher, a buffer (for example, an on-chip buffer or an internal buffer) having a higher memory access speed is selected. As the priority of the packet becomes lower, a buffer (for example, an on-board buffer or an external buffer) having a lower memory access speed is selected. In a case where there are three levels of priority such as high, medium, and low, and there are two buffers 13, a buffer having a relatively high memory access speed may be selected only for a high priority packet, and a buffer having a relatively low memory access speed may be selected for a medium/low priority packet. In this case, a criterion for sorting a high-speed buffer and a low-speed buffer may be set in advance.

The buffer control circuit 14 (buffer selection circuit 14B) selects the buffer 13 for storing the packet, as information for selecting the buffer 13, according to a user ID of the packet, the physical port 11 to which the packet is input, and details of arithmetic operation to be performed on the packet. For example, in a case where a service quality is controlled for each user ID, a buffer having a higher memory access speed is selected for a packet to which a user ID required to ensure a low-delay service quality is allocated, that is, as a service quality of the packet becomes higher. For a packet in which details of arithmetic operation to be performed on the packet are processing that requires a relatively long processing time, the processing time of the memory access is at a level that can be ignored with respect to the entire processing time. Therefore, as a service quality of such a packet becomes lower, a buffer having a lower memory access speed is selected.

The buffer control circuit 14 (buffer selection circuit 14B) checks an operating status of the arithmetic processing circuit 12 in the subsequent stage, and in a case where the type of arithmetic operation to be performed on a packet among packets stored in the buffers 13 matches the type of arithmetic operation that can be supported by the allocatable arithmetic processing circuit 12, the buffer control circuit 14 (buffer selection circuit 14B) allocates the packet to the arithmetic processing circuit 12 and reads the packet from the buffer 13.

As described above, the buffer control circuit 14 (buffer selection circuit 14B) selects the buffer 13 having a different physical performance according to property of a packet (data) to be stored, specifically, a priority or a service quality of the packet.

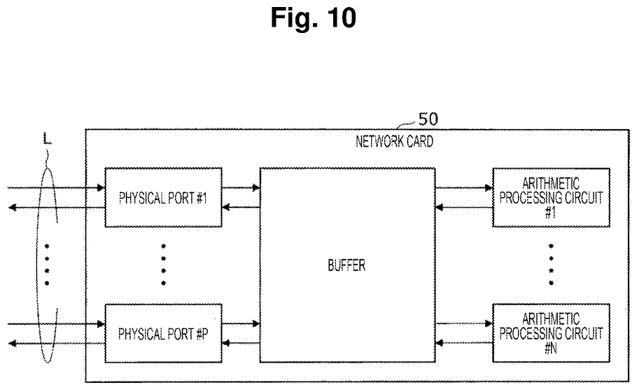

FIG. 10 is a block diagram illustrating a configuration of a network card of the related art. As illustrated in FIG. 10, a network card 50 of the related art includes a buffer that stores input packets as an on-board memory or an on-chip memory, but a storage destination of packets is fixed or specified in advance by a user. In contrast, the network card 10 of embodiments of the present invention is different in that the network card 10 includes a plurality of buffers 13 having different physical properties, and the buffer control circuit 14 is configured to select a storage destination of a packet and dynamically switch storage destinations on the basis of a priority or a service quality of the packet specified from header information of the input packet.

Consequently, a packet with a high priority or a high service quality is stored in a buffer having a relatively high memory access speed among the buffers 13, and a packet with a low priority or a low service quality is stored in a buffer having a relatively low memory access speed. Therefore, it is possible to reduce the processing time of the packet with a high priority or a high service quality, and it is also possible to level a load on the entire system by performing processing of a packet with a low priority or a low service quality during a light load time of the arithmetic processing circuit 12.

In the network card 10 of embodiments of the present invention, an on-chip memory can be used together with an on-board memory as the buffer 13. In this case, since the on-chip memory has relatively small power consumption in terms of memory access, the overall power consumption can be reduced compared with a case where only the on-board memory is used as the buffer 13. Since a memory access speed of the on-chip memory is relatively high, the overall processing time can be reduced. By using the on-board memory and the on-chip memory in combination, both can be operated in parallel, and thus it is possible to suppress a conflict of memory accesses.

On the other hand, in the network card 10 of embodiments of the present invention, an on-board memory can be used together with an on-chip memory as the buffer 13. In this case, since the onboard memory has a relatively large storage capacity, the on-board memory can be applied to an application or a service that handles data having a relatively large size, such as a high-definition image having a large data size or a neural network model, compared with a case where only the on-chip memory is used as the buffer 13. In a case where only the on-chip memory is used, if a storage capacity of the on-chip memory is increased, an area of the chip also increases, and the yield in the manufacturing process deteriorates or the leak power increases. In contrast, if the on-board memory is used together, a storage capacity of the on-chip memory can be reduced, an area of the chip can be reduced, the yield in the manufacturing process can be improved, and the leakage power can be suppressed. By using the on-board memory and the on-chip memory in combination, both can be operated in parallel, and thus it is possible to suppress a conflict of memory accesses.

### Operation of First Embodiment

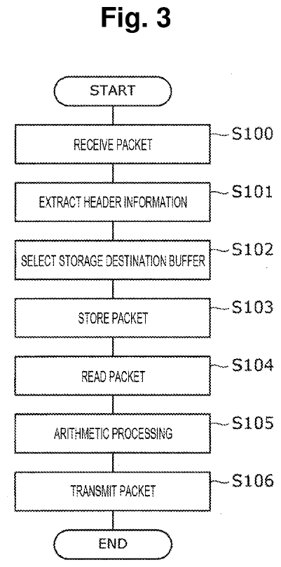

An operation of the network card 10 according to the first embodiment will be described with reference to FIG. 3. FIG. 3 is a flowchart illustrating an operation in a buffer control method for the network card according to the first embodiment.

As illustrated in FIG. 3, first, the physical port 11 receives a packet from an external device, an external network, or an external connection device via the transmission line L (step S100).

Subsequently, the buffer control circuit extracts header information from the packet input from the physical port 11 (step S101) (first step) and selects the buffer 13 as a storage destination of the packet from among the buffers 13 on the basis of the obtained header information (step S102) (second step).

In this case, the buffer control circuit selects the buffer 13 for storing the packet according to, for example, a priority of the packet input from the physical port 11. For example, for a packet with a high priority, a buffer (an on-chip buffer or an internal buffer) having a relatively high memory access speed is selected. For a packet with a low priority, a buffer (an on-board buffer or an external buffer) having a relatively low memory access speed is selected. In a case where there are three levels of priority such as high, medium, and low, and there are two buffers having different physical performances as the buffers 13, a buffer having a relatively high memory access speed is selected only for a high priority packet, and a buffer having a relatively low memory access speed is selected for a medium/low priority packet. In this case, a criterion for sorting a high-speed buffer and a low-speed buffer is set in advance.

The buffer control circuit 14 selects a buffer for storing the packet, as information for selecting the buffer 13, according to a user ID of the packet, the physical port 11 to which the packet is input, and details of arithmetic operation to be performed on the packet. For example, in a case where a service quality is controlled for each user ID, a packet to which a user ID to ensure the low-delay service quality is allocated is stored in a buffer having a relatively high memory access speed. For a packet in which details of arithmetic operation to be performed on the packet are processing that requires a relatively long processing time, the processing time of the memory access is at a level that can be ignored with respect to the entire processing time, and thus, the packet is stored in a buffer having a relatively high memory access speed.

Next, among the buffers 13, the buffer 13 selected by the arithmetic processing circuit 12 temporarily stores the packet input from the arithmetic processing circuit 12 (step S103). These buffers 13 include buffers having different physical performances such as a writing/reading speed and a storage capacity of data.

For example, in the network card 10, a device that performs communication protocol processing, for example, a buffer (hereinafter, also referred to as an on-chip buffer) including an on-chip memory provided inside a field programmable gate array (FPGA) or an application specific integrated circuit (ASIC) has a feature that a memory access speed, that is, a speed of reading and writing data is relatively high although a storage capacity is relatively small. Such an on-chip memory is suitable for storing data of a service that requires low-delay processing, data with high priority, and data of a service with a small storage capacity.

On the other hand, a buffer (hereinafter, also referred to as an on-board buffer) provided outside a device that performs communication protocol processing and including an on-board memory provided on the same printed circuit board as the device has a feature that a memory access speed, that is, a data reading/writing speed, is relatively low. It is known that the on-board memory has relatively large power consumption associated with memory access. However, the on-board memory has a large storage capacity and is suitable for storing data in a case where data for which a processing delay is allowed or a service for which there is a greater need to secure a storage capacity, for example, a high-definition moving image is analyzed by using a large-scale neural network, the time required for subsequent arithmetic operations is longer than the memory access speed, and a processing delay associated with memory access can be ignored.

Thereafter, the buffer control circuit 14 checks whether or not the packet can be allocated on the basis of an operating state of each arithmetic processing circuit 12. Here, in a case where the type of arithmetic operation that can be supported by the allocatable arithmetic processing circuit 12 matches the type of arithmetic operation to be performed on the packet among the packets stored in the respective buffers 13, the buffer control circuit 14 allocates the packet to the arithmetic processing circuit 12, reads the packet from the buffer 13, and outputs the packet to the arithmetic processing circuit 12 (step S104).

Next, the arithmetic processing circuit 12 performs predetermined arithmetic processing on the packet read from the buffer 13 by the buffer control circuit 14 and outputs an obtained arithmetic processing result (step S105).

The buffer control circuit 14 stores the arithmetic processing result output from the arithmetic processing circuit 12 in a packet, transmits the packet as an optical or electrical signal from the physical port 11 (step S106), and ends a series of packet arithmetic processing.

### Effects of First Embodiment

As described above, in the network card 10 of the present embodiment, the buffer 13 includes buffers having different physical performances including a memory access speed or a storage capacity, and the buffer control circuit 14 selects the buffer 13 to be a packet storage destination from among the buffers 13 on the basis of a packet priority or a service quality specified from header information of a packet received by the physical port 11 and the physical performance of the buffer 13.

Consequently, a packet with a high priority or a high service quality is stored in a buffer having a relatively high memory access speed among the buffers 13, and a packet with a low priority or a low service quality is stored in a buffer having a relatively low memory access speed. Therefore, it is possible to reduce the processing time of the packet with a high priority or a high service quality, and it is also possible to level a load on the entire system by performing processing of a packet with a low priority or a low service quality during a light load time of the arithmetic processing circuit 12.

Compared with a case where only an on-board memory is used as the buffer 13, it is possible to utilize an on-chip memory having small power consumption in terms of memory access, and thus it is possible to reduce the power consumption. Since the on-chip memory having a high memory access speed can be utilized, the processing time can be reduced. By using the on-board memory and the on-chip memory in combination, both can be operated in parallel, and thus it is possible to suppress a conflict of memory accesses.

On the other hand, since it is possible to utilize an on-board memory having a large storage capacity compared with a case of using only an on-chip memory, embodiments of the present invention can be applied to an application or a service that handles data having a relatively large size, such as a high-definition image having a large data size or a neural network model. When a storage capacity of the on-chip memory is increased, an area of the chip is also increased, and the yield in the manufacturing process deteriorates or the leak power increases. On the other hand, since the storage capacity of the on-chip memory can be reduced, the area of the chip can be reduced, the yield in the manufacturing process can be improved, and the leak power can be suppressed. By using the on-board memory and the on-chip memory in combination, both can be operated in parallel, and thus it is possible to suppress a conflict of memory accesses.

Since the buffer 13 that is a storage destination is selected according to a priority of the packet, it is possible to select the on-chip memory capable of performing high-speed memory access as a storage destination of the highest priority packet and thus to reduce the processing time. An on-board memory having a large storage capacity can be selected as a storage destination of a packet with a low priority. Consequently, a packet with a high priority can be preferentially stored in an on-chip memory having a small storage capacity, and thus a service quality can be improved without increasing a capacity of the on-chip memory.

Since the buffer 13 that is a storage destination is selected according to service details of a packet, the on-chip memory capable of performing high-speed memory access can be preferentially selected as a storage destination of a packet of a service that requires low delay, and thus an increase in processing time can be suppressed. It is possible to select an on-board buffer having a large storage capacity as a storage destination of a packet of a service with a relatively loose delay request. Consequently, even in a situation in which traffic is congested, a decrease in service quality can be suppressed, and the service quality can be improved without increasing a storage capacity of the on-chip memory.

### Second Embodiment

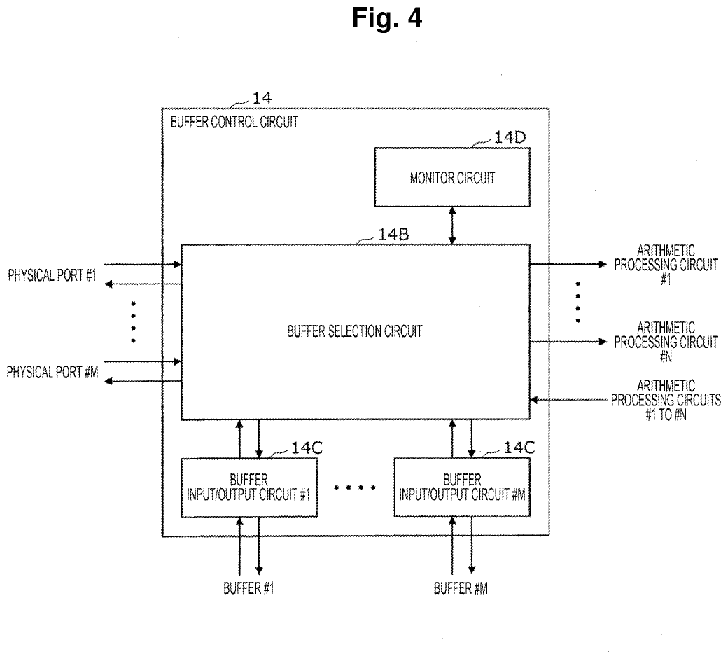

Next, a network card 10 according to a second embodiment of the present invention will be described with reference to FIG. 4. FIG. 4 is a block diagram illustrating a configuration of a buffer control circuit according to a second embodiment.

A difference from the first embodiment is that the buffer control circuit 14 includes a monitor circuit 14D instead of the header extraction circuit 14A.

That is, as illustrated in FIG. 4, in the present embodiment, the monitor circuit 14D is configured to monitor a packet processing status in the entire network card 10, such as a buffer storage amount in all the buffers 13 and a traffic amount (data traffic amount) in all the physical ports 11, and determine whether or not the obtained packet monitoring information exceeds a preset threshold value.

The buffer control circuit 14 (buffer selection circuit 14B) is configured to select a packet storage destination on the basis of the threshold value determination result from the monitor circuit 14D.

For example, in a case where the buffer storage amount of the buffer 13 is used as a packet processing status and the monitor circuit 14D determines that the buffer storage amount does not exceed the threshold value, the buffer control circuit 14 selects a buffer (an on-chip buffer or an internal buffer) having a relatively high memory access speed as a packet storage destination. In a case where the monitor circuit 14D determines that the buffer storage amount exceeds the threshold value, the buffer control circuit 14 selects a buffer (an on-board buffer or an external buffer) having a relatively low memory access speed but a large storage capacity as a packet storage destination.

In the above example, in the case of selecting a storage destination of a packet, the storage destination is dynamically changed on the basis of a packet processing status of the entire network card 10 such as a buffer storage amount in all the buffers 13 or a traffic amount in all the physical ports 11. However, embodiments of the present invention are not limited to this example. For example, a packet storage destination may be selected on the basis of a packet processing status for each physical port 11. In this case, the monitor circuit 14D may monitor a buffer storage amount or a traffic amount for each physical port 11, perform threshold value processing with each threshold value, and select a storage destination according to the obtained comparison result. A packet storage destination may be selected on the basis of both a packet processing status of the entire network card 10 and a packet processing status of each physical port 11.

### Operation of Second Embodiment

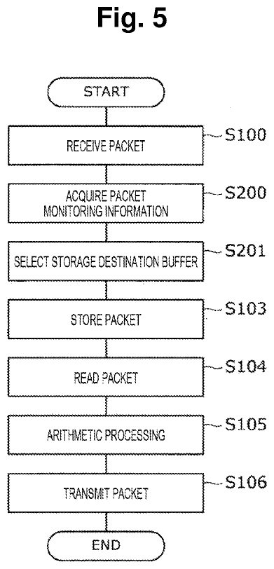

An operation of the network card according to the second embodiment will be described with reference to FIG. 5. FIG. 5 is a flowchart illustrating an operation in a buffer control method for the network card according to the second embodiment.

The operation illustrated in FIG. 5 is different from the operation illustrated in FIG. 3 described above in that steps S200 and S201 are provided instead of steps S101 and S102. The other steps in FIG. 5 are the same as those in FIG. 3, and the description thereof is omitted here.

As illustrated in FIG. 5, in step S100, after the physical port 11 receives a packet via the transmission line L, the buffer control circuit monitors a packet processing status, such as a buffer storage amount in all the buffers 13 or a traffic amount in all the physical ports 11, and acquires obtained packet monitoring information (step S200).

Next, the buffer control circuit compares the obtained packet monitoring information with a preset threshold value, selects the buffer 13 in which the packet is to be stored from among the buffers 13 on the basis of the obtained comparison result (step S201), and proceeds to step S103 described above.

For example, in a case where the buffer storage amount is monitored as the packet monitoring information, and the buffer storage amount does not exceed the threshold value, the buffer control circuit selects the buffer 13 having a relatively high memory access speed as a storage destination. In a case where the buffer storage amount exceeds the threshold value, the buffer control circuit selects the buffer 13 having a relatively low memory access speed but a large storage capacity.

In the above example, the buffer storage amount or the traffic amount of the entire network card 10 is used as the packet monitoring information, but the buffer storage amount or the traffic amount for each physical port 11 may be used. For example, the buffer storage amount or the traffic amount may be monitored as the packet monitoring information for each physical port 11 and compared with each threshold value, and an obtained comparison result may be used to select a storage destination buffer.

### Effects of Second Embodiment

As described above, the network card 10 of the present embodiment includes the monitor circuit 14D that monitors a packet processing status of the entire network card 10, such as a buffer storage amount in all the buffers 13 or a packet traffic amount in all the physical ports 11, and compares obtained packet monitoring information with a preset threshold value, and the buffer control circuit is configured to select a packet storage destination on the basis of a comparison result obtained by the monitor circuit 14D.

Consequently, for example, in a case where the buffer storage amount is used as the packet monitoring information, it is possible to preferentially use an on-chip memory having a small storage capacity as the buffer 13 that is a storage destination and to store a packet in an on-board memory having a large storage capacity in a case where the buffer storage amount increases. Thus, buffer overflow can be suppressed, and retransmission due to buffer overflow can be prevented. It is possible to suppress an increase in processing time such as applying back pressure due to buffer overflow, and thus to improve service quality.

For example, in a case where the traffic amount is used as the packet monitoring information, and the traffic amount is large, the on-board memory having a large storage capacity can be used as the buffer 13 that is a storage destination, and packet loss or buffer overflow can be suppressed. On the other hand, in a case where the traffic amount is small, the on-chip memory capable of performing high-speed memory access can be used, and thus it is possible to suppress an increase in processing time. Since the occurrence of unnecessary traffic such as retransmission can be suppressed by suppressing packet loss, a network load can be reduced. Accordingly, service quality can be improved.

### Third Embodiment

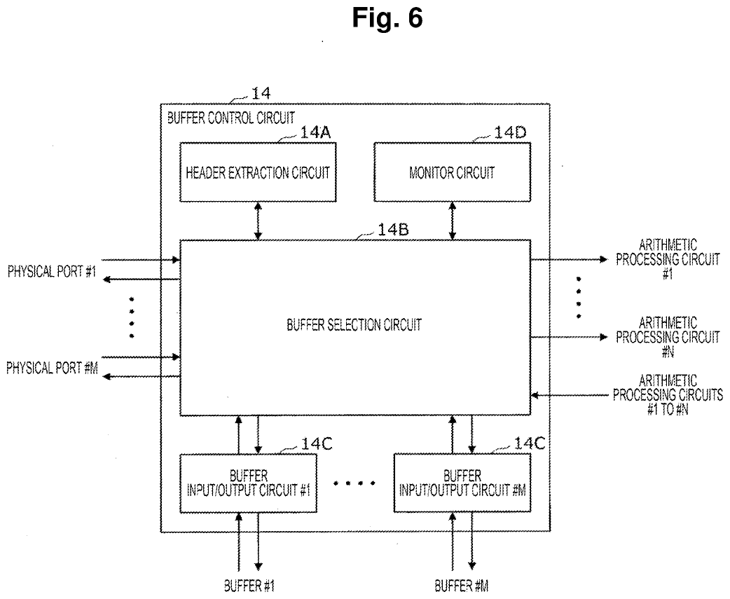

Next, a configuration of a network card according to a third embodiment of the present invention will be described with reference to FIG. 6. FIG. 6 is a block diagram illustrating a configuration of a buffer control circuit according to a third embodiment.

A difference from the first and second embodiments is that the buffer control circuit 14 includes both a header extraction circuit 14A and a monitor circuit 14D.

That is, as illustrated in FIG. 6, in the present embodiment, the header extraction circuit 14A is configured to analyze and extract header information stored in a packet header of a packet input from the physical port 11. Specifically, information for specifying a priority or a user ID of the packet and details of arithmetic operation to be performed on the packet are extracted as header information from a predetermined field of the packet.

The monitor circuit 14D is configured to monitor a packet processing status in the entire network card 10, such as a buffer storage amount in all the buffers 13 or a traffic amount in all the physical ports 11, and determine whether or not obtained packet monitoring information exceeds a preset threshold value.

The buffer control circuit 14 (buffer selection circuit 14B) is configured to select a packet storage destination on the basis of the threshold value determination result from the monitor circuit 14D.

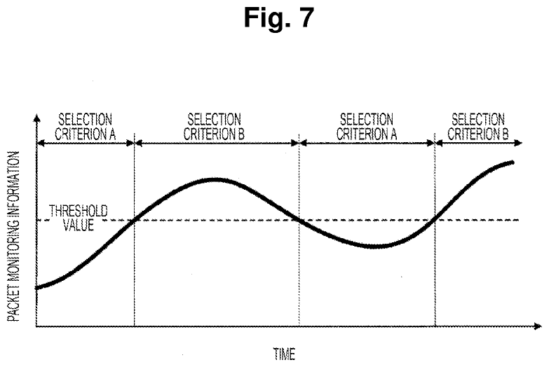

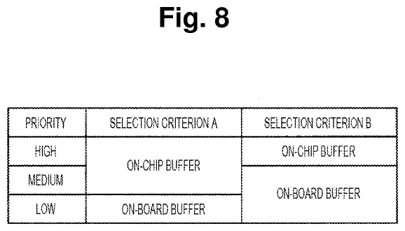

Here, a buffer selection example in the buffer control circuit 14 will be described. FIG. 7 is an explanatory diagram illustrating a buffer selection criterion example. FIG. 8 is a graph illustrating a buffer selection operation example (buffer storage amount) and illustrates an example in which a buffer storage amount is used as buffer processing information. For example, as illustrated in FIG. 7, a configuration is assumed in which three levels of packet priority such as high, medium, and low are set, and two buffers H and L having different physical performances are provided as the buffers 13. A buffer storage amount in all the buffers 13 and a traffic amount in all the physical ports 11 are used as packet monitoring information.

In this configuration, as illustrated in FIG. 8, in a case where the buffer storage amount does not exceed a threshold value, the buffer control circuit 14 selects the buffer H (on-chip buffer) having a relatively high memory access speed as a storage destination of a high/medium priority packet and selects the buffer L having a relatively low memory access speed as a storage destination of a low priority packet on the basis of a selection criterion A in FIG. 7. On the other hand, in a case where the buffer storage amount exceeds the threshold value, the buffer control circuit 14 selects the buffer H having a relatively high memory access speed as a storage destination of a high priority packet and selects the buffer L having a relatively low memory access speed as a storage destination of a medium/low priority packet on the basis of a selection criterion B in FIG. 7.

In a case where the traffic amount does not exceed the threshold value, the buffer control circuit 14 selects the buffer H having a relatively high memory access speed as a storage destination of a high/medium priority packet and selects the buffer L having a relatively low memory access speed as a storage destination of a low priority packet on the basis of the selection criterion A in FIG. 8. On the other hand, in a case where the traffic amount exceeds the threshold value, the buffer control circuit 14 selects the buffer H having a relatively high memory access speed as a storage destination of a high priority packet and selects the buffer L having a relatively low memory access speed as a storage destination of the a medium/low priority packet on the basis of the selection criterion B in FIG. 8.

In the above example, in a case where a storage destination of a packet is selected according to a priority of the packet, an example has been described in which the storage destination is dynamically changed according to a buffer storage amount or a traffic amount, but the storage destination may not necessarily be selected according to the priority of the packet. For example, in a case where the storage destination of the packet is selected on the basis of processing details of the packet, the buffer storage amount or the traffic amount is monitored for each processing detail, and threshold value processing may be performed with each threshold value. In a case where the storage destination of the packet is selected on the basis of a user ID, the buffer storage amount or the traffic amount is monitored for each user ID, and threshold value processing may be performed with each threshold value. In a case where the storage destination of the packet is selected on the basis of the physical port 11, the buffer storage amount or the traffic amount is monitored for each physical port 11, and threshold value processing may be performed with each threshold value.

### Operation of Third Embodiment

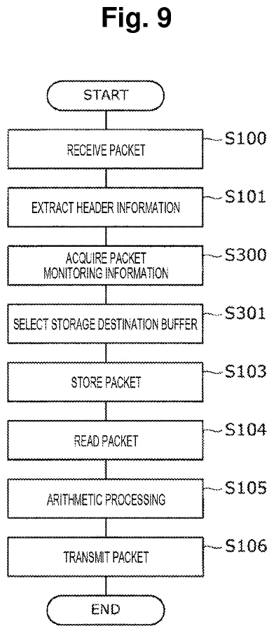

Next, an operation in a buffer control method for the network card according to the third embodiment will be described with reference to FIG. 9. FIG. 9 is a flowchart illustrating an operation of the network card according to the third embodiment.

The operation illustrated in FIG. 9 is different from the operation illustrated in FIG. 3 described above in that steps S300 and S301 are provided instead of step S102. The other steps in FIG. 9 are the same as those in FIG. 3, and the description thereof will be omitted here.

As illustrated in FIG. 9, in step S101, the buffer control circuit extracts header information from the packet input from the physical port 11 and acquires information indicating a priority of the packet, a user ID, information for specifying details of arithmetic processing to be performed on the packet, and the like.

The buffer control circuit monitors a packet processing status such as a buffer storage amount in all the buffers 13 or a traffic amount in all the physical ports 11 and acquires obtained packet monitoring information (step S300).

Next, the buffer control circuit compares the obtained packet monitoring information with a preset threshold value, selects the buffer 13 in which the packet is to be stored from among the buffers 13 on the basis of the obtained comparison result and the header information (step S301), and proceeds to step S103 described above.

In this case, assuming a configuration in which three levels of packet priority such as high, medium, and low are set, and two buffers H and L having different physical performances are provided as the buffers 13 as illustrated in FIG. 7, in a case where the buffer storage amount does not exceed the threshold value, the buffer control circuit 14 selects the buffer H (on-chip buffer) having a relatively high memory access speed as a storage destination of a high/medium priority packet and selects the buffer L having a relatively low memory access speed as a storage destination of a low priority packet on the basis of the selection criterion A in FIG. 7. On the other hand, in a case where the buffer storage amount exceeds the threshold value, the buffer control circuit 14 selects the buffer H having a relatively high memory access speed as a storage destination of a high priority packet and selects the buffer L having a relatively low memory access speed as a storage destination of a medium/low priority packet on the basis of a selection criterion B in FIG. 7.

In a case where the traffic amount does not exceed the threshold value, the buffer control circuit 14 selects the buffer H having a relatively high memory access speed as a storage destination of a high/medium priority packet and selects the buffer L having a relatively low memory access speed as a storage destination of a low priority packet on the basis of the selection criterion A in FIG. 7. On the other hand, when the traffic amount exceeds the threshold value, the buffer control circuit 14 selects the buffer H having a relatively high memory access speed as a storage destination of a high priority packet and selects the buffer L having a relatively low memory access speed as a storage destination of a medium/low priority packet on the basis of the selection criterion B in FIG. 7.

In the above example, the buffer storage amount or the traffic amount of the entire network card 10 is used as the packet monitoring information, but the buffer storage amount or the traffic amount for each physical port 11 may be used. For example, the buffer storage amount or the traffic amount may be monitored as the packet monitoring information for each physical port 11 and compared with each threshold value, and an obtained comparison result may be used to select the buffer 13 that is a storage destination.

### Effects of Third Embodiment

As described above, in the network card 10 of the present embodiment, the buffer control circuit 14 is configured to monitor a packet processing status of the entire network card 10, such as a buffer storage amount in all the buffers 13 or a packet traffic amount in all the physical ports 11, and select a storage destination of a packet on the basis of a comparison result obtained by comparing obtained packet monitoring information with a preset threshold value and a priority or a service quality of the packet specified from header information of the packet.

Consequently, it is possible to select the buffer 13 having a different physical performance for each combination of packet monitoring information such as a buffer storage amount or a traffic amount and a packet priority or a service quality. Thus, packets having different priorities or service qualities can be stored in the optimum buffer 13 according to a packet processing status of the entire network card 10. Therefore, it is possible to fuse priority control of a communication network and allocation control of arithmetic processing on a packet, and as a result, the arithmetic processing can be efficiently executed on the packet.

Since the buffer 13 that is a storage destination is selected according to the priority of the packet, it is possible to preferentially select an on-chip memory capable of performing high-speed memory access as a storage destination of the highest-priority packet and thus to reduce the processing time. An on-board memory having a large storage capacity can be selected as a storage destination of a packet with a low priority. Consequently, a packet with a high priority can be preferentially stored in an on-chip memory having a small storage capacity, and thus a service quality can be improved without increasing a capacity of the on-chip memory.

Since the buffer 13 that is a storage destination is selected according to service details of a packet, the on-chip memory capable of performing high-speed memory access can be preferentially selected as a storage destination of a packet of a service that requires low delay, and thus an increase in processing time can be suppressed. It is possible to select an on-board buffer having a large storage capacity as a storage destination of a packet of a service with a relatively loose delay request. Consequently, even in a situation in which traffic is congested, a decrease in service quality can be suppressed, and the service quality can be improved without increasing a storage capacity of the on-chip memory.

In a case where the buffer storage amount is used as the packet monitoring information, it is possible to preferentially use the on-chip memory having a small storage capacity as a packet storage destination buffer and also store a packet in the on-board memory having a large storage capacity in a case where a buffer storage amount increases. Thus, buffer overflow can be suppressed, and retransmission due to buffer overflow can be prevented. It is possible to suppress an increase in processing time such as applying back pressure due to buffer overflow, and thus to improve service quality.

In a case where the traffic amount is used as the packet monitoring information, and the traffic amount is large, the on-board memory having a large storage capacity can be used as a packet storage destination buffer, and packet loss and buffer overflow can be suppressed. On the other hand, in a case where the traffic amount is small, the on-chip memory capable of performing high-speed memory access can be used, and thus it is possible to suppress an increase in processing time. Since the occurrence of unnecessary traffic such as retransmission can be suppressed by suppressing packet loss, a network load can be reduced. Accordingly, service quality can be improved.

A selection criterion for selecting the on-chip memory or the on-board memory as a storage destination can be changed according to a traffic amount. Therefore, in a case where the traffic amount is large, the on-chip memory can be selected as a storage destination of the highest priority packet, and thus it is possible to suppress an increase in processing time and to suppress deterioration in service quality. On the other hand, in a case where the traffic amount is small, since the on-chip memory can be selected as a storage destination of highest-priority and high-priority packets, it is possible to reduce the power consumption while reducing the processing time of the high-priority packet.

### Extension of Embodiments

Embodiments of the present invention have been described by referring to exemplary embodiments, but are not limited to the above embodiments. Various changes understandable by those skilled in the art can be made for the configurations and details of embodiments of the present invention within the scope of the present invention. The respective embodiments can be implemented in any combination within a consistent scope.

### REFERENCE SIGNS LIST

10 Network card
11 Physical port
12 Arithmetic processing circuit
13 Buffer
13 Buffer control circuit
14A Header extraction circuit
14B Buffer selection circuit
14C Buffer input/output circuit
14D Monitor circuit
L Transmission line

1.-6. (canceled)

7. A network card comprising:
a plurality of physical ports configured to receive and transmit packets via a transmission line;
a plurality of buffers configured to temporarily store the packets received by the plurality of physical ports, each of the plurality of buffers having different physical performances, the different physical performances comprising a memory access speed and a storage capacity;
a plurality of arithmetic processing circuits configured to perform predetermined arithmetic processing on the packets read from the plurality of buffers; and
a buffer control circuit configured to:
specify a priority or a service quality of the packets based on header information of the packets;
select ones of the buffers, from among the plurality of buffers, to be storage destinations of the packets based on the priority or the service quality and the different physical performances of the plurality of buffers;
store the packets in the selected ones of the buffers; and
control allocation of the packets read from the selected ones of the buffers to the plurality of arithmetic processing circuits.

8. The network card according to claim 7, wherein the buffer control circuit is configured to select, from among the plurality of buffers, the ones of the buffers having a higher memory access speed as the priority or the service quality of the packets becomes higher.

9. The network card according to claim 8, wherein the buffer control circuit is configured to select, from among the plurality of buffers, the ones of the buffers having a larger storage capacity as the priority or the service quality of the packets becomes lower.

10. The network card according to claim 9, wherein the buffer control circuit is configured to:
monitor a buffer storage amount of the plurality of buffers or a traffic amount of the plurality of physical ports to obtain packet monitoring information; and
select, from among the plurality of buffers, the ones of the buffers to be the storage destinations of the packets based on the obtained packet monitoring information.

11. The network card according to claim 9, wherein the buffer control circuit is configured to:
monitor a buffer storage amount of the plurality of buffers or a traffic amount of the plurality of physical ports to obtain packet monitoring information; and
select, from among the plurality of buffers, the ones of the buffers to be the storage destinations of the packets based on the obtained packet monitoring information and the priority or the service quality of the packets.

12. The network card according to claim 8, wherein the buffer control circuit is configured to:
monitor a buffer storage amount of the plurality of buffers or a traffic amount of the plurality of physical ports to obtain packet monitoring information; and
select, from among the plurality of buffers, the ones of the buffers to be the storage destinations of the packets based on the obtained packet monitoring information.

13. The network card according to claim 8, wherein the buffer control circuit is configured to:
monitor a buffer storage amount of the plurality of buffers or a traffic amount of the plurality of physical ports to obtain packet monitoring information; and
select, from among the plurality of buffers, the buffers to be the storage destinations of the packets based on the obtained packet monitoring information and the priority or the service quality of the packets.

14. The network card according to claim 7, wherein the buffer control circuit is configured to select, from among the plurality of buffers, the ones of the buffers having a larger storage capacity as the priority or the service quality of the packets becomes lower.

15. The network card according to claim 7, wherein the buffer control circuit is configured to:
monitor a buffer storage amount of the plurality of buffers or a traffic amount of the plurality of physical ports to obtain packet monitoring information; and
select, from among the plurality of buffers, the ones of the buffers to be the storage destinations of the packets based on the obtained packet monitoring information.

16. The network card according to claim 7, wherein the buffer control circuit is configured to:
monitor a buffer storage amount of the plurality of buffers or a traffic amount of the plurality of physical ports to obtain packet monitoring information; and
select, from among the plurality of buffers, the buffers to be the storage destinations of the packets based on the obtained packet monitoring information and the priority or the service quality of the packets.

17. A buffer control method used in a network card, the network card comprising a plurality of physical ports that receive and transmit packets via a transmission line, a plurality of buffers, of which physical performances comprising a memory access speed and a storage capacity are different, that temporarily store the packets received by the plurality of physical ports, a plurality of arithmetic processing circuits that perform predetermined arithmetic processing on the packets read from the plurality of buffers, and a buffer control circuit that stores the packets in any of the plurality of buffers and controls allocation of the packets read from the plurality of buffers to the plurality of arithmetic processing circuits, the buffer control method comprising:
causing the buffer control circuit to specify a priority or a service quality of the packets based on header information of the packets; and
causing the buffer control circuit to select ones of the buffers from among the plurality of buffers to be storage destinations of the packets based on the priority or the service quality of the packets and the physical performances of the plurality of buffers.

18. The buffer control method according to claim 17, wherein causing the buffer control circuit to select the ones of the buffers comprises causing the buffer control circuit to select the ones of the buffers having a higher memory access speed as the priority or the service quality of the packets becomes higher.

19. The buffer control method according to claim 17, wherein causing the buffer control circuit to select the ones of the buffers comprises causing the buffer control circuit to select the ones of the buffers having a larger storage capacity as the priority or the service quality of the packets becomes lower.

20. The buffer control method according to claim 17, further comprising:
monitoring a buffer storage amount of the plurality of buffers or a traffic amount of the plurality of physical ports to obtain packet monitoring information; and
selecting, from among the plurality of buffers, the ones of the buffers to be the storage destinations of the packets based on the obtained packet monitoring information.

21. The buffer control method according to claim 17, further comprising:
monitoring a buffer storage amount of the plurality of buffers or a traffic amount of the plurality of physical ports to obtain packet monitoring information; and
selecting, from among the plurality of buffers, the ones of the buffers to be the storage destinations of the packets based on the obtained packet monitoring information and the priority or the service quality of the packets.
